(19) United States
(12) Patent Application Publication
(10) Pub. No.: US 2004/0141255 A1
(43) Pub. Date: Jul. 22, 2004

(54) Magnetic head device and recording/reproducing apparatus using the same

(76) Inventors: Kazushi Ogawa, Kanagawa (JP); Tadashi Ozue, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/705,154

(22) Filed: Nov. 11, 2003

(30) Foreign Application Priority Data
Nov. 13, 2002 (JP) JP2002-330025

(51) Int. Cl. G11B 5/10

(52) U.S. Cl. 360/129

(57) ABSTRACT

A magnetic head device including: a first magnetic head for performing recording in a first magnetic track on a magnetic tape in the longitudinal direction when the magnetic tape runs in one direction; a second magnetic head for performing recording in a second magnetic track parallel to the first magnetic track when the magnetic tape runs in another direction; and a reproducing head disposed between the two magnetic heads is provided. Each of the two magnetic heads has a lower core and an upper core having a width equal to or smaller than the lower core. The two magnetic heads and the reproducing head are arrayed parallel to the running direction of the magnetic tape, and each of the two magnetic heads is so disposed that the upper core precedes the lower core in relation to the running direction of the magnetic tape when recording on the respective magnetic tracks.

### CROSS REFERENCE TO RELATED APPLICATIONS

The present document claims priority to Japanese Priority Document JP 2002-330025, filed in the Japanese Patent Office on Nov. 13, 2002, the entire contents of which are incorporated herein by reference to the extent permitted by law.

### BACKGROUND OF THE INVENTION

1. Field of the Invention

The present invention relates to a magnetic head device employing a so-called linear recording method and a recording/reproducing apparatus using the same. More particularly, the present invention is concerned with a technique which suppresses a side erase region due to recording magnetic field fringing in a magnetic recording head device produced by a thin film fabrication process thereby increasing recording density.

2. Description of Related Art

Conventionally, as a recording head for recording signals on a magnetic recording medium, a so-called bulk type magnetic head has been used, which comprises a pair of magnetic cores comprised of a magnetic material facing each other to form a magnetic path, a very small magnetic gap between the pair of magnetic cores, and a coil wound around the magnetic cores to generate a magnetic field.

On the other hand, as recording density is becoming increasingly advanced, a so-called metal in gap (MIG) type magnetic head has been put to practical use, which comprises a pair of magnetic cores comprised of ferrite or the like, and metallic magnetic thin films having a high saturation magnetic flux density deposited on the surfaces of the magnetic cores facing each other, wherein these metallic magnetic thin films face each other through a non-magnetic film serving as a magnetic gap.

Generally, a recording head achieves the recording of signals by a method in which an electric current corresponding to recording signals is supplied to a coil, and a magnetic field generated from the coil causes a magnetic flux to flow through a pair of magnetic cores and a recording magnetic field is generated in a magnetic gap, and the recording magnetic field is applied to a recording medium which runs in a state where the medium is in contact with or close to the tips of the magnetic cores.

In this recording head, in order to meet the demands for increasing recording density, it is becoming more important that the track width be reduced and the precision of the track width improved. However, with the above-mentioned magnetic head, there are limitations in terms of production with fine processing, and it is difficult to reduce the track width to support increased recording density.

To this end, as a recording head supporting increased recording density, a so-called thin film magnetic head in which elements are layered on a substrate by a thin film fabrication technique has been proposed. In the thin film magnetic head, because its elements, such as a magnetic core and a coil, are formed by a thin film fabrication technique, e.g., a plating process, a sputtering process, or an ion milling process, reducing the size of the magnetic head, for example, by reducing the track width or gap width is easy, and it is possible to increase the recording density of the magnetic recording medium by reducing the size of the magnetic head.

Here, a thin film magnetic head 100 used in the magnetic recording head of a hard disk drive apparatus is shown in FIGS. 9 and 10. With a slider 102 as a substrate, where the slider 102 lets the thin film magnetic head 100 float when a disc-shaped recording medium 101 is run, the thin film magnetic head 100 is formed by forming a first magnetic core 103 on the slider 102 and then forming a second magnetic core 105 on the first magnetic core 103 with a non-magnetic film 104 in between.

The thin film magnetic head 100 is provided at a lower portion of the rear end edge of the slider 102. The rear end of the slider 102 as used here refers to the end portion towards the back in relation to the relative running direction of the disc-shaped recording medium 101.

Therefore, when recording magnetic signals on the disc-shaped recording medium 101, the first magnetic core 103 precedes the second magnetic core 105, that is, the first magnetic core 103 is on the leading side, and the second magnetic core 105 is on the trailing side.

The running disc-shaped recording medium 101 causes an air flow and the slider 102 of the thin film magnetic head 100 in the hard disk drive apparatus receives the air flow and floats above the disc-shaped recording medium 101, so that the thin film magnetic head 100 is in a state where it is close to the disc-shaped recording medium 101 (not in contact with the disc-shaped recording medium 101, however).

The thin film magnetic head 100 is formed so that the width of the first magnetic core 103 is greater than the width of the second magnetic core 105. In the following descriptions, the widths of the layered magnetic core layers will be expressed in relative terms, where the layer having the larger width will be referred to as a “wide layer” and the layer having the smaller width will be referred to as a “narrow layer”.

As shown in FIG. 11, by using a thin film fabrication process, it is easy to form, on a wide layer 106 as a base, a narrow layer 107 having a width smaller than the width of the layer serving as a base, but when the wide layer 106 is formed on the narrow layer 107, as shown in FIG. 12, because both end portions of the wide layer 106 in the widthwise direction drape over both end portions of the narrow layer 107 and become round, it is difficult to form a film having a desired form, for example, a rectangular form.

In order to deposit the wide layer 106 on the narrow layer 107 formed in advance, special steps, for example as shown in FIG. 13, such as depositing supporting layers 108, 108 adjacent to the narrow layer 107 on the left and right thereof and such that each has the same thickness as the narrow layer 107, and then depositing the wide layer 106 on the narrow layer 107 and the supporting layers 108, 108 must be taken.

However, even when such steps are taken, because it is not easy to form the narrow layer 107 and the supporting layers 108, 108 adjacent to the left and right of the narrow layer 107 with the same thickness, it is hard to give the wide layer 106 deposited on these layers the desired form. For example, in FIG. 14 is shown a case where the supporting layers 108, 108 deposited adjacent to the left and right of the narrow layer 107 are thinner than the narrow layer 107. In contrast to FIG. 14, when the supporting layers 108, 108 are formed thicker than the narrow layer 107, the left and right ends of the wide layer 106 deposited on the narrow layer 107 end up becoming bent upward, and therefore the wide layer 106 cannot be formed in the desired form.

Further, as shown in FIG. 15, sometimes a gap is formed between the narrow layer 107 and the supporting layers 108, 108 deposited on both sides of the narrow layer 107. When the wide layer 106 is deposited thereon, it tends not to take on the desired form.

For this reason, when the thin film magnetic head 100 is produced by a thin film fabrication process as mentioned above, the first magnetic core 103 is generally formed to have a width greater than the width of the second magnetic core 105.

[Patent Document 1]

Japanese Patent Application Publication No. Hei7-93711

[Patent Document 2]

Japanese Patent Application Publication No. Hei11-306513

### SUMMARY OF THE INVENTION

However, as mentioned above, in the thin film magnetic head 100, the width of the first magnetic core 103 on the leading side is greater than the width of the second magnetic core 105 on the trailing side, and hence there is a problem in that a side erase region due to so-called recording magnetic field fringing becomes larger and it becomes difficult to disregard from the viewpoint of signal-to-noise (S/N) ratio.

In other words, magnetic signals to be recorded are derived from leakage magnetic fields generated between the first magnetic core 103 on the leading side and the second magnetic core 105 on the trailing side, and the leakage magnetic fields include, as shown in FIG. 16, a leakage magnetic field α generated between the first magnetic core 103 and an edge portion 110 of the second magnetic core 105 on the magnetic gap side, and a leakage magnetic field β generated between the first magnetic core 103 and both ends 111, 111 of the second magnetic core 105 in the widthwise direction of the head.

The leakage magnetic field α generated between the first magnetic core 103 and the edge portion 110 of the second magnetic core 105 on the magnetic gap side is in a direction parallel to the running direction of the disc-shaped recording medium 101 with respect to the edge portion 110 of the second magnetic core 105 on the magnetic gap side, and the magnitude of the leakage magnetic field α is largest in the magnetic gap and rapidly becomes smaller as it approaches the trailing side from the edge portion 110 of the second magnetic core 105 on the magnetic gap side. Therefore, the record pattern recorded by the leakage magnetic field α generated between the first magnetic core 103 and the edge portion 110 of the second magnetic core 105 on the magnetic gap side is, as indicated with the letter “a” in FIG. 17, in a form that substantially follows the shape of the edge portion 110 of the second magnetic core 105 on the magnetic gap side.

In comparison, the leakage magnetic field β generated between the first magnetic core 103 and both ends 111, 111 of the second magnetic core 105 in the widthwise direction of the head is in a direction perpendicular or substantially perpendicular to the running direction of the disc-shaped recording medium 101 with respect to both ends 111, 111 of the second magnetic core 105. In addition, the magnitude of the leakage magnetic field β gradually becomes smaller along both sides 111, 111 of the second magnetic core 105 as it approaches the trailing side from the portions connected to the magnetic gap-side edge portion 110 to the trailing side. Therefore, the record pattern recorded by the leakage magnetic field β generated between the first magnetic core 103 and both sides 111, 111 of the second magnetic core 105 shows, as indicated with the letter “b” in FIG. 17, a shape extending to the trailing side from the portions connected to the edge portion 110 of the second magnetic core 105.

As a result, when recording magnetic signals, the difference between the direction of the leakage magnetic field α with respect to the edge portion 110 of the second magnetic core 105 on the magnetic gap side and the direction of the leakage magnetic field β with respect to both sides 111, 111 of the second magnetic core 105, and the difference in the rate of the reduction in magnitude of the individual leakage magnetic fields with respect to the running direction of the disc-shaped recording medium 101 cause, in a record pattern 112 of one bit, a portion a by the leakage magnetic field α and portions b, b which extend backward to be generated. FIG. 17 is a schematic view showing the record pattern 112 of one bit, illustrating how in the record pattern 112, both side portions b, b in the widthwise direction of the track extend backward in a strip shape.

It is thought that this is because the second magnetic core 105 (the magnetic core having a smaller width) on the trailing side does not have portions that face, in the running direction of the disc-shaped recording medium 101, both end portions of the first magnetic core 103 (the magnetic core having a larger width) on the leading side.

The set of the strip-shaped portions b, b, may also be referred to as trailing portions, in a record pattern of a bit overwrites the record pattern 112 of a previous bit that is already recorded to cause a so-called side erase, and the effective width of the record tracks becomes smaller, leading to a problem which is that the S/N ratio is lowered.

Specifically, as shown in FIG. 17, when a record pattern of one bit is formed so that, for example, the width of the record pattern (which is substantially the same as the width of the first magnetic core 103) is 1.96 μm and the length in the record track direction is 1 μm, the base-side of the strip-shaped portions b, b formed by both end portions of the record pattern in the widthwise direction of the track extending backward ends up with a width of 0.21 μm and a length of 0.4 μm.

When record patterns 112 of a plurality of bits having such a shape are formed, as shown in FIG. 18, the strip-shaped portions b, b of record pattern 112b overwrite the record pattern 112a of a bit previously formed. Thus, the width of the effective record pattern 112 of the bit becomes

1.96−0.21×2=1.54 μm.

For this reason, as mentioned above, even though the recorded tracks are formed with the magnetic core (the first magnetic core) 103 having a width of 1.96 μm, the width of the effective recorded tracks is only 1.54 μm, causing a problem which is that the S/N ratio is lowered.

Among the various methods of magnetic tape recording, there is the linear recording method in which magnetic recording is performed in the longitudinal direction of the magnetic tape. In the linear recording method, a magnetic tape horizontally runs over a plurality of magnetic heads mounted on a head block to read or write data in a linear manner from or on the magnetic tape.

Generally, in the linear recording method, physical tracks are arrayed in the widthwise direction of the magnetic tape, about eight magnetic heads are mounted on the head block, about eight tracks are recorded per running of the tape, and this is repeated for all tracks to achieve data recording on one tape. The eight magnetic heads on the head block record data on the first track set (eight tracks) across the whole length of the tape. Once the end of the tape is reached, the head block moves the magnetic heads in the widthwise direction of the magnetic tape so that the individual magnetic heads can record data on the subsequent tracks. Then, the running direction of the magnetic tape is reversed, and data is recorded on the subsequent eight tracks across the whole length of the tape. In the linear recording method, this procedure is repeated until recording is completed with respect to the entire width of the magnetic tape.

### SUMMARY OF THE INVENTION

Even with such magnetic heads formed on a head block employing the linear recording method, a set of the strip-shaped portions b, b (trailing portions) of a record pattern of a bit overwrites the record pattern 112 of a bit previously recorded to cause so-called side erase as mentioned above, and the effective width of the recorded tracks becomes smaller. As a result, there arises a problem where the S/N ratio is lowered, thus making it difficult to increase the recording density in magnetic recording.

A task of the present invention is to provide a magnetic head device and a recording/reproducing apparatus using the same, which suppress side erase caused by so-called recording magnetic field fringing even when employing the linear recording method, and thus increase the recording density in magnetic recording.

In order to solve the problems above, the present invention provides a magnetic head device for recording and reproducing an information signal on/from a magnetic tape employing a linear recording method, the magnetic head device comprising: a first thin film magnetic head for recording in one magnetic track formed on the magnetic tape in the longitudinal direction of the magnetic tape when the magnetic tape runs in one direction, wherein the first thin film magnetic head has a lower core and an upper core which are formed so as to have a predetermined gap therebetween, and the upper core has a width equal to or smaller than the width of the lower core; a second thin film magnetic head for recording in another magnetic track formed on the magnetic tape in a direction parallel to the magnetic track mentioned above when the magnetic tape runs in another direction, wherein the second thin film magnetic head has a lower core and an upper core which are formed so as to have a predetermined gap therebetween, and the upper core has a width equal to or smaller than the width of the lower core; and a reproducing magnetic head, which is disposed between the first and second thin film magnetic heads, for reproducing information signals recorded in the magnetic tracks mentioned above. In this magnetic head device, the first and second thin film magnetic heads and the reproducing magnetic head are arranged parallel to the running direction of the magnetic tape, and the first and second thin film magnetic heads are individually disposed so that their upper cores precede their lower cores with respect to the running direction of the magnetic tape when recording in the respective magnetic tracks.

Further, the present invention provides a recording/reproducing apparatus employing a linear recording method, the apparatus comprising tape running means for running a magnetic tape, and a magnetic head device for recording or reproducing an information signal on or from the magnetic tape, wherein the magnetic head device comprises: a first thin film magnetic head for recording in one magnetic track formed on the magnetic tape in the longitudinal direction of the magnetic tape when the magnetic tape runs in one direction, wherein the first thin film magnetic head has a lower core and an upper core which are formed so as to have a predetermined gap therebetween, and the upper core has a width equal to or smaller than the width of the lower core; a second thin film magnetic head for recording in another magnetic track formed on the magnetic tape in a direction parallel to the magnetic track mentioned above when the magnetic tape runs in another direction, wherein the second thin film magnetic head has a lower core and an upper core which are formed so as to have a predetermined gap therebetween, and the upper core has a width equal to or smaller than the width of the lower core; and a reproducing magnetic head, which is disposed between the first and second thin film magnetic heads, for reproducing information signals recorded in the magnetic tracks mentioned above. The first and second thin film magnetic heads and the reproducing magnetic head are arranged parallel to the running direction of the magnetic tape, and the first and second thin film magnetic heads are individually disposed so that their upper cores precede their lower cores with respect to the running direction of the magnetic tape when recording in the respective magnetic tracks.

In a magnetic head device and a recording/reproducing apparatus related to the present invention, the first and second thin film magnetic heads and the reproducing magnetic head are arranged parallel to the running direction of the magnetic tape, and the first and second thin film magnetic heads are individually disposed so that their upper cores precede their lower cores with respect to the running direction of the magnetic tape when recording on the respective magnetic tracks. Therefore, with respect to each of the first and second thin film magnetic heads, because the upper core having a smaller width is arranged to always be on the leading side in relation to the running direction of the magnetic tape in either running direction, the magnetic tape first contacts the upper core having a smaller width and then contacts the lower core having a larger width, and thus, the problem of recording magnetic field fringing does not arise.

In other words, the width of the upper core on the leading side is smaller than the width of the lower core on the trailing side, and hence the pattern recorded by the leakage magnetic field generated from both end portions of the upper core in the widthwise direction can be settled by the leakage magnetic field generated at the edge portion on the magnetic gap side of the lower core on the trailing side. Thus, the strip-shaped portions which are conventionally generated in the record pattern are hardly generated at all, and the problem of so-called side erase where both side portions of a previously recorded pattern are overwritten by part of the subsequent record pattern can be solved, making it possible to increase the magnetic recording density.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a plan view showing the structure of a magnetic recording/reproducing apparatus to which the present invention is applied and which is for use with a magnetic tape cartridge;

FIG. 2 is a plan view showing a magnetic head block to which the present invention is applied;

FIG. 3 is a diagram showing recording tracks on a magnetic tape;

FIG. 4 is a plan view showing the construction of a thin film magnetic head to which the present invention is applied;

FIG. 5 is a cross-sectional view of the thin film magnetic head taken along line X-X′ in FIG. 4;

FIG. 6 is a record pattern of one bit recorded on a magnetic tape;

FIG. 7 is an enlarged view showing record patterns of a plurality of bits;

FIG. 8 is a plan view showing a magnetic head block with which a running magnetic tape is in contact;

FIG. 9 is an enlarged plan view showing a magnetic recording head in a conventional hard disk drive apparatus;

FIG. 10 is an enlarged cross-sectional view showing a magnetic recording head in a conventional hard disk drive apparatus;

FIG. 11 is a cross-sectional view showing a state where, in a thin film fabrication process, a layer having a smaller width is formed on a base layer;

FIG. 12 is a cross-sectional view showing a state where, in a thin film fabrication process, a wide layer is formed on a narrow layer as a base;

FIG. 13 is a cross-sectional view showing a state where a wide layer is formed on a narrow layer using supporting layers;

FIG. 14 is a cross-sectional view showing a state where a wide layer is formed on a narrow layer using supporting layers;

FIG. 15 is a cross-sectional view showing a state where a wide layer is formed on a narrow layer using supporting layers;

FIG. 16 is a diagram showing a magnetic flux generated between the first magnetic core and the second magnetic core;

FIG. 17 is an enlarged view showing a record pattern of one bit recorded by a conventional magnetic head device; and

FIG. 18 is an enlarged view showing record patterns recorded by a conventional magnetic head device where a plurality of bits are formed.

### DESCRIPTION OF THE PREFERRED EMBODIMENTS

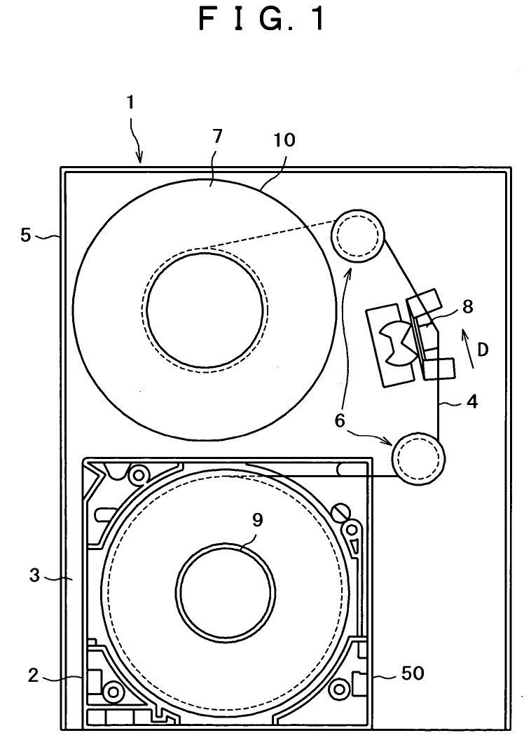

Below, a magnetic head device and a recording/reproducing apparatus to which the present invention is applied will be described in detail with reference to the drawings. A recording/reproducing apparatus 1 using a magnetic head device to which the present invention is applied is a drive apparatus, as shown in FIG. 1, for recording or reproducing on or from a magnetic tape wound in, for example, a single reel tape cartridge, and is a magnetic recording/reproducing apparatus employing a linear recording method for performing magnetic recording on the magnetic tape in the longitudinal direction of the magnetic tape.

The magnetic recording/reproducing apparatus 1 has a cartridge loading section 3 into which a tape cartridge 2 is loaded, a carrying mechanism (not shown) for pulling a magnetic tape 4 of the tape cartridge 2 loaded into the cartridge loading section 3 out into an apparatus main body 5 and for carrying the magnetic tape 4 along a predetermined running path, a winding portion 7 for winding the magnetic tape 4 carried into the apparatus main body 5, and a magnetic head block 8 which contacts the magnetic tape 4 carried into the apparatus main body 5 to record or reproduce information signals.

The cartridge loading section 3 has a cartridge insert/eject opening formed in one side surface portion of the apparatus main body 5 of the magnetic recording/reproducing apparatus 1, and a loading mechanism for loading or unloading the tape cartridge 2 inserted into the apparatus main body 5. At the loading position for the tape cartridge 2 is formed a reel driving mechanism for rotating a tape reel 9, which is housed in the tape cartridge 2 and around which the magnetic tape 4 is wound. The loading mechanism carries the tape cartridge 2 inserted through the cartridge insert/eject opening to the loading position so that the tape cartridge 2 is engaged with the reel driving mechanism. The reel driving mechanism runs the magnetic tape inside the apparatus main body 5, and also rewinds the magnetic tape 4 that has been fed into the apparatus main body 5 back into the tape cartridge 2 by rotating and driving the tape reel 9. Once recording or reproducing is completed and the magnetic tape 4 is rewound back into the tape cartridge 2, the loading mechanism carries the tape cartridge 2 from the loading position to the unloading position and ejects it through the cartridge insert/eject opening.

The carrying mechanism has a tape pulling member for pulling the magnetic tape 4 out from the tape cartridge 2, and a guide mechanism 6 for guiding the movement of the tape pulling member that has pulled the magnetic tape 4 out. The tape pulling member enters the tape cartridge 2 carried to the loading position, and engages with a leader block provided at an end portion of the magnetic tape 4 and pulls the magnetic tape 4 out into the apparatus main body 5. The tape pulling member engaged with the end portion of the magnetic tape 4 is guided by the guide mechanism 6 so that the magnetic tape 4 contacts the magnetic head block 8 described below and the magnetic tape 4 is carried to the winding portion 7 for winding the magnetic tape 4.

The winding portion 7 has a winding reel 10 for winding the magnetic tape 4 carried into the apparatus main body 5 by the carrying mechanism, and a rotational driving mechanism for rotating and driving the winding reel 10. Once the magnetic tape 4 carried by the carrying mechanism is wound around the winding reel 10, the winding reel 10 runs and winds the magnetic tape 4 by being rotated by the rotational driving mechanism. The magnetic tape 4 runs over the magnetic head block 8 in the direction indicated by arrow D in FIG. 1 or in the opposite direction by having the winding reel 10 rotated and driven by the rotational driving mechanism for the winding reel 10 or by having the tape reel 9 rotated and driven by the reel driving mechanism for driving the tape reel 9 provided in the cartridge loading section 3.

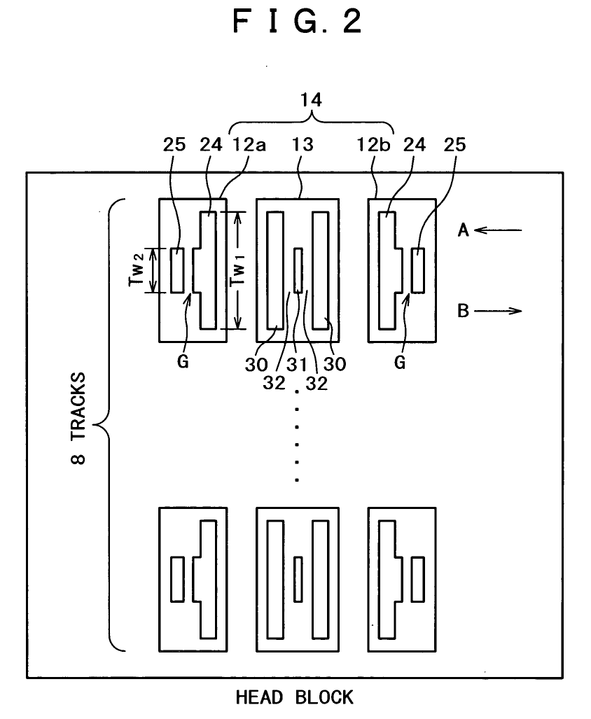

The magnetic head block 8 for recording or reproducing information signals on or from the magnetic tape 4 running in the apparatus main body 5 performs magnetic recording in the longitudinal direction of the magnetic tape 4, that is, the magnetic head block 8 performs magnetic recording employing a so-called linear recording method, and, as shown in FIG. 2, it has a recording/reproducing head 14 which comprises a pair of recording heads 12a and 12b formed parallel to the running direction of the magnetic tape 4, and a reproducing head 13 formed between the recording heads 12a and 12b. In the magnetic head block 8, a plurality, for example eight, of such recording/reproducing heads 14 are arrayed in the widthwise direction of the magnetic tape 4.

Using the plurality of recording/reproducing heads 14 arrayed in the widthwise direction of the magnetic tape, the magnetic head block 8 linearly writes a plurality of tracks (e.g., eight tracks) on the magnetic tape 4 sliding horizontally. In other words, by having the magnetic tape 4 run between the tape reel 9 and the winding reel 10, the magnetic head block 8 records data across the whole length of the magnetic tape 4. Once the end of the tape is reached, the magnetic head block 8 is moved so that each recording/reproducing head 14 can write data in the next recording track adjacent in the widthwise direction of the magnetic tape 4. Then, the running direction of the magnetic tape 4 is reversed, and the magnetic head block 8 linearly records data again in the next plurality of tracks across the whole length the magnetic tape 4.

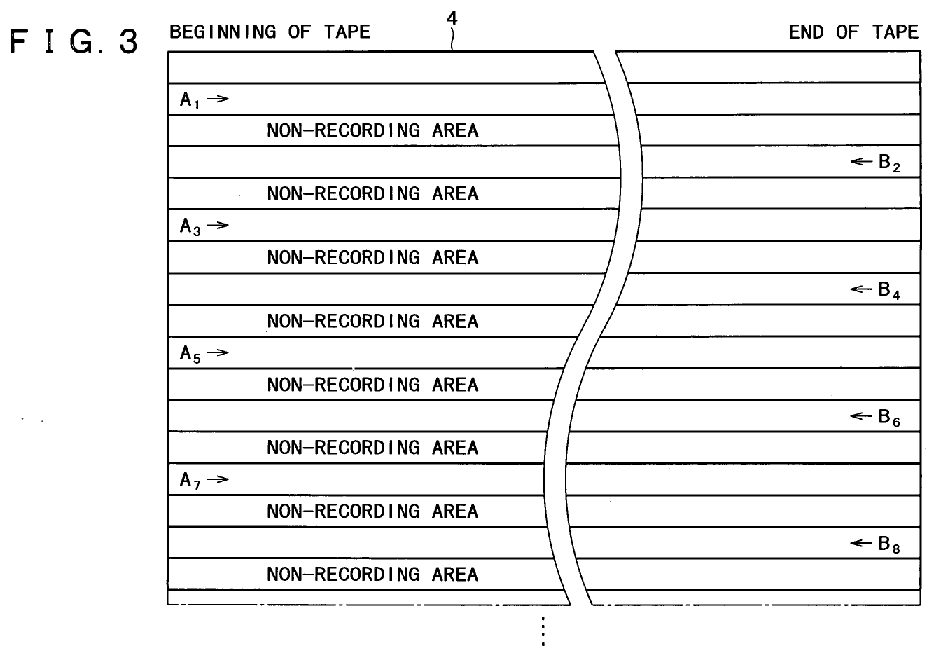

In other words, as shown in FIG. 3, when the magnetic tape 4 runs in the direction indicated by arrow A shown in FIG. 2, the recording/reproducing heads 14 write data in a linear fashion in eight recording tracks, which are A₁, A₃, A₅, . . . , A₁₅. After the recording of data in the recording tracks A across the entire length of the magnetic tape 4 is complete, the recording/reproducing heads 14 are moved in the widthwise direction of the magnetic tape 4 to a position corresponding to eight recording tracks which are B₂, B₄, B₆, . . . , B₁₆, and the running direction of the magnetic tape 4 is reversed so that the magnetic tape 4 runs in the direction indicated by arrow B shown in FIG. 2 to write data in a linear fashion in recording tracks B. Thereafter, recording is performed across the entire length of the magnetic tape 4, and each time the running direction of the magnetic tape 4 is reversed, data is recorded in the physical tracks formed and aligned across the width of the magnetic tape 4 in order, namely, A→B→A→ . . .

Generally, using the recording/reproducing heads 14 that support eight tracks and which are arrayed in the widthwise direction of the magnetic tape 4, the magnetic head block 8 records eight tracks' worth of data per running of the magnetic tape 4.

As the recording/reproducing heads 14 for writing data, so-called thin film magnetic heads in which various elements are layered on a substrate by a thin film fabrication technique are used. In the recording/reproducing head 14 comprised of thin film magnetic heads, since various elements, such as a magnetic core and a coil, are formed on a substrate by a thin film fabrication technique, such as a plating process, a sputtering process, an ion milling process or the like, the width of the track can be reduced, thus making it possible to further increase the recording density of the magnetic recording medium.

Each of the recording heads 12a and 12b is an inductive type magnetic head in which a pair of magnetic cores 15 and 16 comprised of a soft magnetic material are joined with a magnetic gap G in between comprised of a non-magnetic material, and a coil is wound around the magnetic cores. The recording heads 12a and 12b each have a structure in which a thin film magnetic head 20 is formed on a first magnetic head member 21 comprised of a non-magnetic material, and a second head member 23 comprised of a non-magnetic material is adhered on the thin film magnetic head 20 via a protective layer 22.

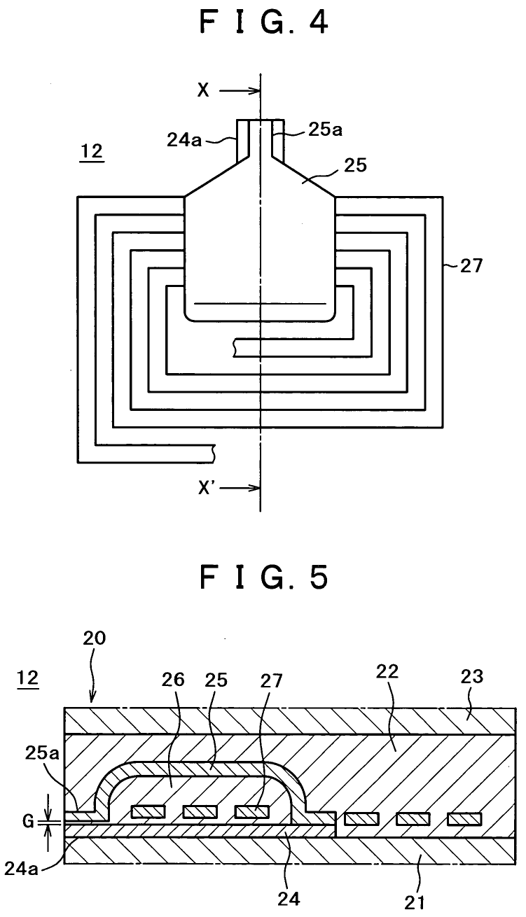

As shown in FIGS. 2 to 5, the thin film magnetic head 20 comprises a lower magnetic core layer 24 and an upper magnetic core layer 25, which form a magnetic pat and which are layered on the first magnetic head member 21. The lower magnetic core layer 24 and the upper magnetic core layer 25 have, at the end portions of their medium contact surfaces which face the magnetic tape 4, protruding portions 24a and 25a, respectively, protruding with predetermined track widths Tw₁ and Tw₂, respectively, corresponding to the recording tracks formed on the magnetic tape 4, and the magnetic gap G is formed by having the protruding portions 24a and 25a face each other with a non-magnetic layer 26 in between.

Thus, in the thin film magnetic head 20, by providing the lower magnetic core layer 24 with the protruding portion 24a which faces the protruding portion 25a of the upper magnetic core layer 25, the recording magnetic field from the magnetic gap G can be narrowed in the widthwise direction of the track, and fine recording bits can be recorded in the recording tracks on the magnetic tape 4.

In the thin film magnetic head 20, the lower magnetic core layer 24 and the upper magnetic core layer 25 are formed so that the track width Tw₂ of the upper magnetic core layer 25 is smaller than the track width Tw₁ of the lower magnetic core layer 24.

In addition, at the other end portion of the thin film magnetic head 20 away from the medium contact surface in the depthwise direction, a back gap, which is a joint portion, is formed by having the lower magnetic core layer 24 and the upper magnetic core layer 25 joined. Between the lower magnetic core layer 24 and the upper magnetic core layer 25, a thin film coil 27 wound with the back gap at the center is provided so as to be embedded in the non-magnetic layer 26.

In the recording heads 12a and 12b, as shown in FIG. 2, the upper magnetic core layers 25 are arranged on both end sides in relation to the running direction of the magnetic tape 4 so that, with respect to the directions indicated by arrow A or arrow B which indicate running directions of the magnetic tape 4, the protruding portion 25a of the upper magnetic core layer 25 is always on the leading side and the protruding portion 24a of the lower magnetic core layer 24 is always on the trailing side. In the magnetic head block 8 employing a linear recording method, the magnetic tape 4 could be run in either of the directions indicated by arrow A and arrow B shown in FIG. 2, but by arranging the recording heads 12 in such a manner as described above, regardless of which of the directions indicated by arrow A and arrow B shown in FIG. 2 the magnetic tape 4 is run in, by selectively driving one of the pair of recording heads 12a and 12b, it is possible to record data with the upper magnetic core layer 25 always on the leading side preceding the lower magnetic core layer 24.

For example, when the magnetic tape 4 runs in the direction indicated by arrow A shown in FIG. 2, the recording head 12b is driven so that the upper magnetic core layer 25 of the recording head 12b is on the leading side. On the other hand, when the magnetic tape 4 runs in the direction indicated by arrow B shown in FIG. 2, the recording head 12a is driven, so that the upper magnetic core layer 25 of the recording head 12a is on the leading side.

In the recording head 12 having the above-described construction, when an electric current corresponding to a recording signal is supplied from an external circuit to the thin film coil 27, a magnetic field generated from the thin film coil 27 causes a magnetic flux to flow through the lower magnetic core layer 24 and the upper magnetic core layer 25 and a recording magnetic field is generated in the magnetic gap G. Then, by applying the recording magnetic field to the magnetic tape 4, record tracks in which record bits corresponding to the recording signal are recorded are formed.

The reproducing head 13 is a magnetoresistive magnetic head (hereinafter referred to as “MR head”) having a magnetoresistive element (hereinafter referred to as “MR element”) as a magnetic sensing element for detecting signals from the magnetic tape 4. As shown in FIG. 2, the reproducing head 13 has a pair of magnetic shielding layers 30, 30 arrayed on both sides of the reproducing head 13 and parallel to the running direction of the magnetic tape 4, and an MR element 31 formed between the magnetic shielding layers 30, 30. In addition, the reproducing head 13 comprises a thin film magnetic head formed on a substrate by a thin film fabrication technique as in the above-described recording head 12.

The reproducing head 13 is a so-called shielded MR head in which the MR element 31 is disposed between the pair of the magnetic shielding layers 30, 30 with magnetic gap layers 32, 32 in between.

In the reproducing head 13, the magnetic shielding layers 30, 30 have sufficient width for magnetically shielding the MR element 31, and by having the MR element 31 disposed between the magnetic shielding layers 30, 30, of the signal magnetic fields from the magnetic tape 4, those which are not subject to reproduction are prevented from being drawn into the MR element 31. In other words, in the reproducing head 13, the signal magnetic fields, which are not subject to reproduction with respect to the MR element 31, are led to the pair of magnetic shielding layers 30, 30, and only the signal magnetic fields that are subject to reproduction are led to the MR element 31. Thus, in the reproducing head 13, the frequency characteristics and reading resolution of the MR element 31 are improved.

The pair of magnetic gaps 32, 32 magnetically isolate, respectively, the pair of magnetic shielding layers 30, 30 from the MR element 31, and the space between the individual magnetic shielding layers 30, 30 and the MR element 31 is referred to as the gap length.

The MR element 31 utilizes the so-called magnetoresistive effect where the electric resistance changes in response to a change in the external magnetic field, and by having a sense current flow through the MR element 31 and detecting changes in the voltage of this sense current, signals recorded on the magnetic tape 4 are read.

When recording data on the magnetic tape 4 by means of the recording heads 12, the MR element 31 is always downstream of the driven recording head 12 in relation to the running direction of the magnetic tape 4. Therefore, the data recorded by the recording heads 12 can be read immediately, thus enabling so-called read-after-write for checking whether the signals are accurately recorded.

For example, eight recording/reproducing heads 14 each comprising the recording heads 12 and the reproducing head 13 are arrayed on the magnetic head block 8 in the widthwise direction of the magnetic tape 4, and simultaneously apply a recording magnetic field onto the recording tracks on the magnetic tape 4. In this case, as mentioned above, since in the recording/reproducing heads 14, the upper magnetic core layers 25 are arranged so as to be on the leading side in relation to the running direction of the magnetic tape 4, the magnetic tape 4 first contacts the upper magnetic core layer 25 having a smaller width and then contacts the lower magnetic core layer 24 having a larger width. Thus, in the recording/reproducing head 14 to which the present invention is applied, the problem of recording magnetic field fringing does not occur.

Specifically, the width of the upper magnetic core layer 25 on the leading side is smaller than the width of the lower magnetic core layer 24 on the trailing side, and hence the record pattern recorded by the leakage magnetic field generated from both end portions of the upper magnetic core layer 25 in relation to the widthwise direction can be settled by the leakage magnetic field generated at the edge portion on the magnetic gap G-side of the lower magnetic core layer 24 on the trailing side. Thus, there are generated almost no strip-shaped portions b, b, which were conventionally found in record patterns, and the problem of so-called side erase where both side portions of the record pattern previously recorded are overwritten by part of the subsequent record pattern can be solved.

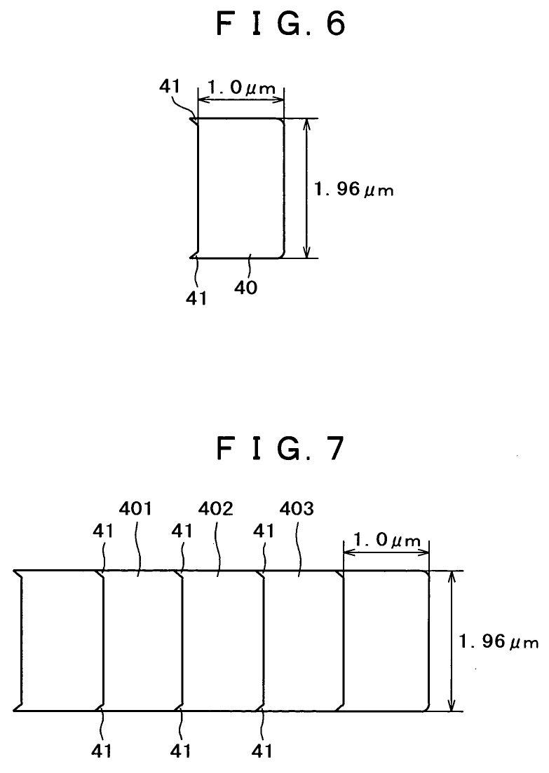

FIG. 6 is a schematic view showing a record pattern 40 of one bit recorded on the magnetic tape 4 by the recording/reproducing head 14, and it can be seen that almost no strip-shaped portions b, b are formed in the record pattern 40 at both side portions 41, 41 in relation to the widthwise direction of the track. Thus, even when record patterns 40 for a plurality of bits are formed, for example, as shown in FIG. 7, getting parts of both sides of a record pattern 401 of an already formed bit overwritten by a subsequent recording pattern 402 hardly occurs at all, and the problem of so-called side erase does not occur.

Further, in the recording/reproducing head 14, the reproducing head 13 is provided between the pair of recording heads 12a and 12b, and the reproducing head 13 is always downstream of the driven recording head 12 in relation to the running direction of the magnetic tape 4. Therefore, the signals recorded by one of the recording heads 12 can be read immediately by the reproducing head 13, thus enabling so-called read-after-write for checking whether the signals are accurately recorded.

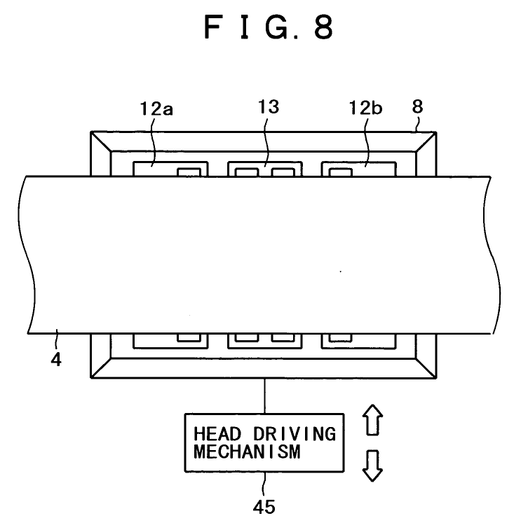

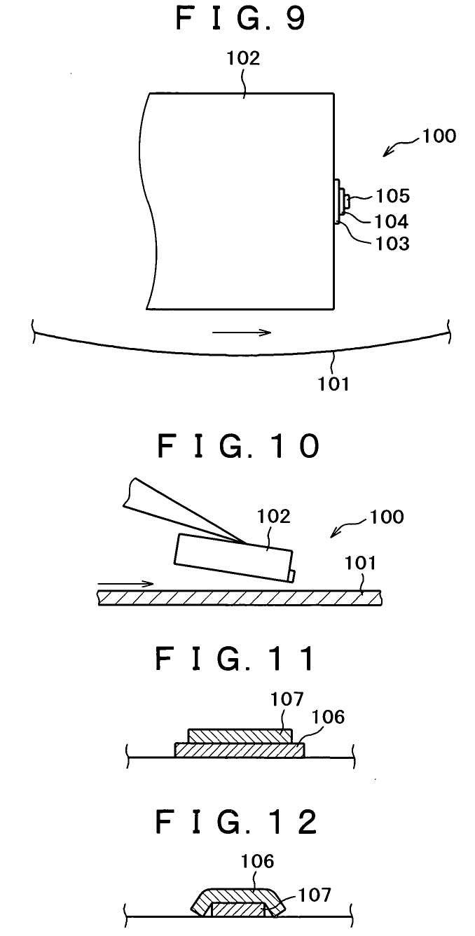

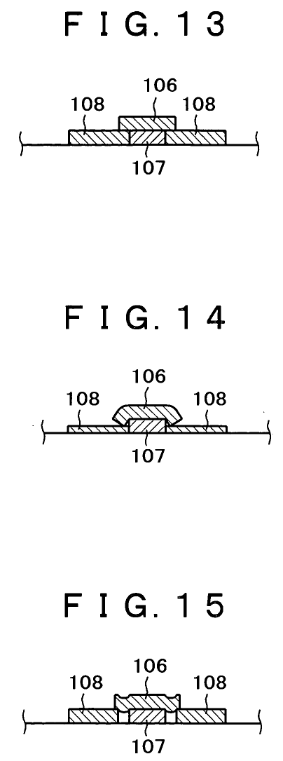

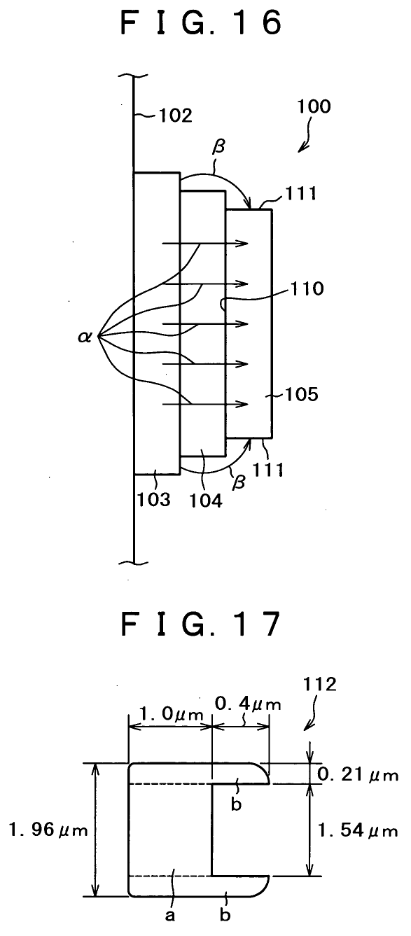

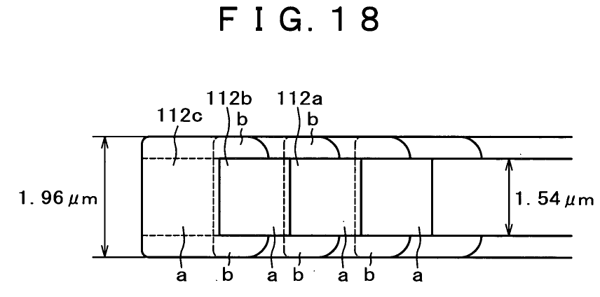

The magnetic head block 8 in which a plurality of such recording/reproducing heads 14 are arrayed across the width of the magnetic tape 4 is, as shown in FIG. 8, connected to a head driving mechanism 45 which moves in the widthwise direction of the magnetic tape 4. The head driving mechanism 45 moves the magnetic head block 8 in the widthwise direction of the magnetic tape 4 according to the positions of the recording tracks on the magnetic tape 4 for the recording/reproducing heads 14. Thus, the recording/reproducing heads 14 can record in one recording track and then once finished with that track, record in another recording track.

The tape cartridge 2 used in the magnetic recording/reproducing apparatus 1 is described below. The tape cartridge 2 is a single reel type tape cartridge, and has a cartridge body 50 that is formed by having a pair of upper and lower halves each formed in a substantially rectangular shape joined together, and a tape reel 9 housed in the cartridge body 50 and around which the magnetic tape 4 as a recording medium is wound.

Provided on one end, the magnetic tape 4 wound around the tape reel 9 has a leader block with which the tape pulling member of the carrying mechanism is engaged, and the magnetic tape 4 is housed in the cartridge body 50, together with the leader block through a tape pulling hole formed in one side surface portion of the cartridge body 50. Physical tracks are arrayed on the magnetic tape 4 in the widthwise direction and, for example, eight tracks are recorded on the magnetic tape 4 each time the magnetic tape 4 runs over the magnetic head block 8 in one direction. Once recording on a track set (eight tracks) over the whole length of the magnetic tape 4 is completed, the running direction is reversed and the magnetic tape 4 runs over the magnetic head block 8 in the other direction so as to record on the subsequent track set (eight tracks).

As the magnetic tape 4, besides a so-called coated tape formed by dispersing ferromagnetic powder in a binder and applying it onto a non-magnetic substrate, a so-called evaporated tape formed by evaporating a metallic magnetic film onto a non-magnetic support at an oblique angle may also be used. In this case, the evaporated tape is superior in coercive force, residual magnetization, and squareness ratio and has particularly good electromagnetic conversion characteristics at short wavelengths. Further, in evaporated tapes, as compared to coated tapes, since the magnetic layer can be formed extremely thin, evaporated tapes are advantageous in that recording demagnetization and thickness loss during reproduction are small, and that since there is no need to use a binder, which is a non-magnetic material, in the magnetic layer, the filling density of the magnetic material can be increased and greater magnetization can be achieved. Therefore, by using an evaporated tape as the magnetic tape 4 in the tape cartridge 2, electromagnetic conversion characteristics can be improved, making it possible to obtain larger output.

Next, the operation of the magnetic recording/reproducing apparatus 1 is described. When the tape cartridge 2 is loaded into the apparatus main body 5, the magnetic tape 4 is carried by the carrying mechanism to the winding portion 7 via the magnetic head block 8, and the magnetic tape 4 is run in the direction indicated by arrow A in FIG. 2 from the tape reel 9 to the winding reel 10. At this point, the recording/reproducing heads 14 formed in the magnetic head block 8 are each placed at positions corresponding to the eight recording tracks A₁, A₃, A₅, . . . , A₁₅ shown in FIG. 3 among the plurality of the recording tracks arrayed on the magnetic tape 4 in the widthwise direction.

When the magnetic tape 4 runs in the direction indicated by arrow A shown in FIG. 2, in each of the recording/reproducing heads 14, an electric current corresponding to the recording signal is supplied from an external circuit to the thin film coil 27 of the recording head 12b, a magnetic field generated from the thin film coil 27 causes a magnetic flux to flow through the lower magnetic core layer 24 and the upper magnetic core layer 25, and a recording magnetic field is generated in the magnetic gap G. Then, by applying this recording magnetic field to the magnetic tape 4, recording tracks in which recording bits corresponding to the recording signals are recorded are formed.

In this case, in the recording head 12b, the upper magnetic core layer 25 having a smaller width is on the leading side preceding the lower magnetic core layer 24 in relation to the running direction of the magnetic tape 4, and hence the record pattern recorded by the leakage magnetic field generated from both end portions of the upper magnetic core layer 25 in the widthwise direction can be settled by the leakage magnetic field generated at the edge portion on the magnetic gap G-side of the lower magnetic core layer 24 on the trailing side. Thus, in the magnetic head block 8 to which the present invention is applied, the strip-shaped portions b, b, which were conventionally generated in record patterns, are hardly generated at all and the problem of so-called side erase where both side portions of the previously recorded record pattern are overwritten by part of the subsequent record pattern can be solved, thereby making it possible to increase the magnetic recording density.

In addition, in each of the recording/reproducing heads 14, the reproducing head 13 is provided downstream of the recording head 12b in relation to the running direction of the magnetic tape 4, and hence the signals recorded by the recording head 12b can be reproduced immediately by the reproducing head 13, thus enabling so-called read-after-write for checking whether the signals are accurately recorded.

When the recording of data is performed up to the end of the magnetic tape, the magnetic head block 8 is moved by the head driving mechanism 45 in the widthwise direction of the magnetic tape 4, so that the recording/reproducing heads 14 are each at positions corresponding to the eight recording tracks B₂, B₄, B₆, . . . , B₁₆, respectively, shown in FIG. 3 among the plurality of recording tracks arrayed on the magnetic tape 4 in the widthwise direction. Then, the running direction of the magnetic tape 4 is reversed, and the magnetic tape 4 runs in the direction indicated by arrow B in FIG. 2 from the winding reel 10 to the tape reel 9. Each recording/reproducing head 14 records data in one of the recording tracks B by means of the recording head 12a.

In this case, in the recording head 12a, too, the upper magnetic core layer 25 is on the leading side preceding the lower magnetic core layer 24 in relation to the running direction of the magnetic tape 4, and hence the record pattern recorded by the leakage magnetic field generated from both end portions of the upper magnetic core layer 25 in the widthwise direction can be settled by the leakage magnetic field generated at the edge portion on the magnetic gap G-side of the lower magnetic core layer 24 on the trailing side. Thus, the strip-shaped portions b, b, which were conventionally generated in record patterns are hardly generated at all, and the problem of so-called side erase can be solved, thereby making it possible to increase the magnetic recording density.

In addition, in each of the recording/reproducing heads 14, the reproducing head 13 is provided downstream of the recording head 12a in relation to the running direction of the magnetic tape 4, and therefore the signals recorded by the recording head 12a can be reproduced immediately by the reproducing head 13, thus enabling so-called read-after-write for checking whether or not the signals are accurately recorded.

Further, in the magnetic recording/reproducing apparatus 1 of the present invention, a pair of the recording heads 12a and 12b are arrayed parallel to the running direction of the magnetic tape 4, and one reproducing head 13 is disposed between the recording heads 12a and 12b. Therefore, by simply providing one reproducing head, so-called read-after-write for checking whether or not signals are accurately recorded can be achieved regardless of the direction in which the magnetic tape 4 runs.

The magnetic recording/reproducing apparatus 1 to which the present invention is applied is described above, however the tape cartridge 2 used with the present invention is not limited to the above-described single reel type tape cartridge and may also include a 2-reel type tape cartridge.

Thus, since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalents of the claims are intended to be embraced therein.

What is claimed is:

1. A magnetic head device for recording and reproducing an information signal on a magnetic tape employing a linear recording method, said magnetic head device comprising:
a first thin film magnetic head including a lower core and an upper core formed with a predetermined gap between itself and said lower core and with a width equal to or narrower than said lower core, where said first thin film magnetic head performs recording in a first magnetic track formed on said magnetic tape in the longitudinal direction of said magnetic tape when said magnetic tape runs in one direction;
a second thin film magnetic head including a lower core and an upper core formed with a predetermined gap between itself and said lower core and with a width equal to or narrower than said lower core, where said second thin film magnetic head performs recording in a second magnetic track formed on said magnetic tape parallel to said first magnetic track when said magnetic tape runs in another direction; and
a reproducing magnetic head disposed between said first and second thin film magnetic heads and which is for reproducing an information signal recorded in said magnetic tracks, wherein
said first and second thin film magnetic heads and said reproducing magnetic head are arranged parallel to the running direction of said magnetic tape, and
each of said first and second thin film magnetic heads is so disposed that said upper core precedes said lower core in relation to the running direction of said magnetic tape when recording in said magnetic tracks.

2. The magnetic head device according to claim 1, wherein a plurality of recording/reproducing units each comprising said first and second thin film magnetic heads and said reproducing magnetic head are arrayed in the widthwise direction of said magnetic tape.

3. A recording/reproducing apparatus employing a linear recording method, said recording/reproducing apparatus comprising a tape running means for running a magnetic tape, and a magnetic head device for recording or reproducing an information signal on said magnetic tape, wherein
said magnetic head device comprises:
a first thin film magnetic head including a lower core and an upper core formed with a predetermined gap between itself and said lower core and with a width equal to or narrower than said lower core, where said first thin film magnetic head performs recording in a first magnetic track formed on said magnetic tape in the longitudinal direction of said magnetic tape when said magnetic tape runs in one direction;
a second thin film magnetic head including a lower core and an upper core formed with a predetermined gap between itself and said lower core and with a width equal to or narrower than said lower core, where said second thin film magnetic head performs recording in a second magnetic track formed on said magnetic tape parallel to said first magnetic track when said magnetic tape runs in another direction; and
a reproducing magnetic head disposed between said first and second thin film magnetic heads and which is for reproducing an information signal recorded in said magnetic tracks, wherein
said first and second thin film magnetic heads and said reproducing magnetic head are arranged parallel to the running direction of said magnetic tape, and
each of said first and second thin film magnetic heads is so disposed that said upper core precedes said lower core in relation to the running direction of said magnetic tape when recording in said magnetic tracks.

4. The recording/reproducing apparatus according to claim 3, wherein, in said magnetic head device, a plurality of recording/reproducing units each comprising said first and second thin film magnetic heads and said reproducing magnetic head are arrayed in the widthwise direction of said magnetic tape.
